(19) United States
(12) Patent Application Publication
(10) Pub. No.: US 2021/0155815 A1
(43) Pub. Date: May 27, 2021

(54) BLACK INKJET INK COMPOSITION

(71) Applicant: Hewlett-Packard Development Company, L.P., Spring, TX (US)

(72) Inventors: Sundar Vasudevan, Corvallis, OR (US); Raymond Adamic, Corvallis, OR (US); Max Yen, San Diego, CA (US)

(21) Appl. No.: 17/047,035

(22) PCT Filed: Aug. 1, 2018
(86) PCT No.: PCT/US2018/044788

§ 371 Date: Oct. 12, 2020

(30) Foreign Application Priority Data
Apr. 30, 2018 (US) PCT/US2018/030217

(51) Int. Cl. C09D 11/328; C09D 11/324; C09D 11/322; C09D 11/037; C09D 11/033; C09B 67/22; B41M 5/00

(52) U.S. Cl. CPC C09D 11/328; C09D 11/324; C09D 11/322; B41M 5/0023; C09D 11/033; C09B 67/0036; C09B 67/0038; C09D 11/037

(57) ABSTRACT

A black inkjet ink composition includes a carbon black pigment; a dispersion synergist having an aromatic structure substituted with at least one solubilizing moiety selected from the group consisting of an ionic moiety, a non-ionic moiety, and a combination thereof; a polar solvent; and water. A method for making the black inkjet ink composition and a printing method using the same is also disclosed.

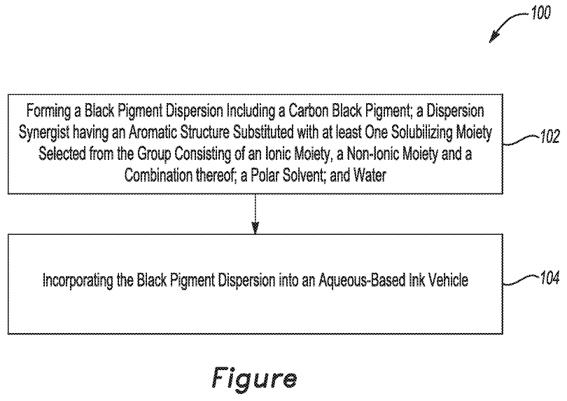

### CROSS-REFERENCE TO RELATED APPLICATIONS

This application claims priority to International Patent Application Number PCT/US2018/030217 filed Apr. 30, 2018, the contents of which are incorporated by reference herein in its entirety.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Some commercial and industrial inkjet printers utilize fixed printheads and a moving substrate web in order to achieve high speed printing. Current inkjet printing technology involves forcing the ink drops through small nozzles by thermal ejection, piezoelectric pressure or oscillation onto the surface of the media. The technology has become a popular way of recording images on various media surfaces (e.g., paper), for a number of reasons, including, low printer noise, capability of high-speed recording and multi-color recording.

### BRIEF DESCRIPTION OF THE DRAWING

Features of examples of the present disclosure will become apparent by reference to the following detailed description and drawing.

The FIGURE is a flow diagram of an example of a method of making an example of the black inkjet ink composition disclosed herein.

### DETAILED DESCRIPTION

In inkjet printing, the ink composition can affect both the printability of the ink and the print attributes of images that are formed with the ink. As such, ink performance, in terms of both printability and printed image attributes, may be controlled by modifying the components of the ink composition. It is also desirable for the ink composition to be stable so that the ink can be jetted reliably. By “stable,” it is meant that the solid components remain dispersed in the ink vehicle. Unstable inks may impact print nozzle health, print reliability and print consistency.

Solid ink components that are prone to settling and thus contribute to ink instability include pigment colorants. Ink instability resulting from pigment colorants may be minimized by chemical modification of the pigment, or by including a suitable pigment dispersant in the ink formulation.

Carbon black is a black pigment that is widely used as the colorant in black ink formulations. Carbon black is inherently insoluble in water. To facilitate dispersion of the carbon black particles within an aqueous-based ink, and thereby enhance the ink stability, a dispersant may be used in conjunction with the carbon black. Alternatively, the carbon black pigment may be chemically modified to yield a self-dispersed carbon black pigment. Self-dispersed carbon black pigments can be dispersed in an aqueous medium without a separate dispersant. Some examples of chemical modifications that can render carbon black self-dispersible include surface oxidation or diazo coupling of small molecule dispersants.

Many inks formulated with self-dispersed carbon black, or with a combination of carbon black and a separate dispersant exhibit reliable stability. However, these same carbon black inks may result in a non-neutral hue on print media, including specialty media (e.g., coated media such as brochure and photo paper). When a hue is non-neutral, the a* color coordinate (i.e., the color channel for color opponents green-red) and/or the b* color coordinate (i.e., the color channel for color opponents blue-yellow) deviate(s) from zero. As such, a non-neutral hue may be slightly blue, slightly red, slightly green, or slightly magenta.

As used herein, coated media is paper which has been coated with a mixture of materials or a polymer to impart certain qualities to the paper, such as weight, surface gloss, smoothness, and/or reduced ink absorbency. An example of coated paper is XEROX® Bold Coated Gloss Digital Printing Office Paper (from Xerox Corporation).

In attempts to achieve more neutral black prints, process black has been printed in combination with cyan ink, magenta ink, and/or yellow ink (CMY inks). Appropriate proportions of the CMY color(s) are dispensed with the black in order to achieve a neutral black hue. In other attempts to achieve more neutral black prints, photo black inks have been formulated, which include the combination of a carbon black dispersion and another color (cyan, magenta and/or yellow) dispersion.

Examples of the black inkjet ink composition disclosed herein include carbon black pigment, and are also stable, and capable of forming prints that exhibit a neutral hue when printed on a variety of different types of media, including plain paper (paper that has not been specially coated or designed for specialty uses (e.g., photo printing)), enhanced paper (paper that has not been specially coated, but does include an additive, such as calcium chloride or another salt, that produces a chemical interaction with a pigment in an ink that is printed thereon), and coated paper.

In the examples disclosed herein, the carbon black pigments are dispersed with a dye dispersion synergist or a pigment derivative dispersion synergist. The dye or pigment derivative dispersion synergist is selected from the group consisting of a cyan dispersion synergist, a magenta dispersion synergist, a yellow dispersion synergist, and combinations thereof. Some of the synergists are dyes that include a solubilizing moiety. Others of the synergists are pigment derivatives. Pigment derivatives have the same unsubstituted backbone as the corresponding pigment from which the dispersion synergist is derived, but is substituted with at least one solubilizing moiety. Each cyan, magenta, and yellow dye or pigment derivative dispersion synergist is a water-soluble or water-miscible dispersion synergist having an at least partially aromatic structure. It is believed that the structural similarities between the carbon black aromatic sheets and the aromatic structure of each dispersion synergist disclosed herein render the two components chemically compatible. This chemical compatibility improves the interaction of the dye or pigment derivative with the carbon black to disperse the carbon black pigment in the aqueous medium. The dispersion characteristics impart stability to the black inkjet ink, thus contributing to the jetting reliability and performance of the black inkjet ink.

The chemical compatibility of the carbon black and the dispersion synergists may also simplify the chemistry involved in preparing the inks disclosed herein (e.g., when compared to making an ink with structurally different dispersants).

Still further, in addition to sufficiently dispersing the carbon black, the dye or pigment derivative dispersion synergist also adds cyan, magenta, and/or yellow color to the ink. It is believed that this color contributes to the black ink's ability to generate printed images with a neutral black hue. With the example inks disclosed herein, images with neutral black hues can be obtained without printing multiple inks together and without having to add additional color dispersions with the carbon black.

The black inkjet inks disclosed herein may also generate prints which are durable, e.g., in terms of water fastness, resistance to curling, etc. The inkjet ink composition can be digitally jetted with a thermal inkjet printhead. It is to be understood, however, that the formulation may also be adjusted for a piezoelectric printhead.

Black Inkjet Ink Compositions

The black inkjet ink composition comprises a carbon black pigment, a dispersion synergist having an aromatic structure substituted with at least one solubilizing moiety selected from the group consisting of an ionic moiety, a non-ionic moiety and a combination thereof, a polar solvent, and water.

In an example, the black inkjet ink composition includes these components (e.g., carbon black pigment, dispersion synergist, polar solvent, etc.) without other additives. In another example, the black inkjet ink composition includes these components (e.g., carbon black pigment, dispersion synergist, polar solvent, etc.), as well as a metal oxide. In still other examples, the black inkjet ink composition includes these components (e.g., carbon black pigment, dispersion synergist, polar solvent, etc.) as well as other additives suitable for inkjet inks, such as, sugar alcohol(s), anti-kogation agent(s), surfactant(s), humectant(s), biocide(s), materials for pH adjustment, sequestering agent(s), binder(s), and/or the like. In still another example, the inkjet ink composition consists of a carbon black pigment, a dispersion synergist, a polar solvent, and a balance of water, as well as the metal oxide and any one or more of the previously listed additives.

The black inkjet ink composition includes the carbon black pigment, which may be present in the black inkjet ink composition in an amount ranging from about 2 wt % to about 5 wt % based on the total weight of the inkjet ink composition. In an example, the amount of carbon black pigment in the black inkjet ink composition ranges from about 2 wt % to about 3 wt % based on the total weight of the black inkjet ink composition. In another example, the amount of the carbon black pigment in the black inkjet ink composition ranges from about 2.5 wt % to about 5 wt % based on the total weight of the black inkjet ink composition. In still another example, the amount of carbon black pigment in the black inkjet ink composition ranges from about 3.5 wt % to about 5 wt % based on the total weight of the black inkjet ink composition. These percentages are percentages of the active carbon black pigment in the ink, and do not account for other components of a pigment dispersion (e.g., dispersant, water, polar solvent) that may be added to the ink with the carbon black.

Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, the MOGUL® series, or the MONARCH® series manufactured by Cabot Corporation, Boston, Mass., (such as, e.g., REGAL® 400R, REGAL® 330R, REGAL® 660R, MOGUL® E, MOGUL® L, AND ELFTEX® 410); and various black pigments manufactured by Evonik Degussa Orion Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® U, PRINTEX® V, PRINTEX® 140U, Special Black 5, Special Black 4A, and Special Black 4.

Carbon black pigment is structurally similar to graphite. Carbon black has extended aromatic sheets in the primary structure, and may have a secondary structure of varying porosity. There are different types of carbon black and each differs in its secondary structure.

In the examples disclosed herein, the carbon black pigment and the dispersion synergist are structurally similar in that both components possess aromatic groups. However, within the chemical structure of the dispersion synergist, at least one aromatic group further contains at least one solubilizing moiety selected from the group consisting of an ionic moiety, a nonionic moiety, and a combination thereof.

In an example, the solubilizing moiety is the ionic moiety and the ionic moiety is selected from the group consisting of a sulfonate, a carboxylate, a phosphonate, an amine, and combinations thereof, or the solubilizing moiety is the non-ionic moiety and the non-ionic moiety is selected from the group consisting of poly(ethylene glycol), poly(propylene glycol), a sulfonamide, a carboxamide, a urethane, and combinations thereof. In another example, the solubilizing moiety includes the combination of the ionic moiety and the non-ionic moiety, wherein the ionic moiety is selected from the group consisting of a sulfonate, a carboxylate, and a phosphonate, and wherein the non-ionic moiety is selected from the group consisting of a sulfonamide and a carboxamide. As further examples wherein the solubilizing moiety includes the combination of the ionic moiety and the non-ionic moiety, the non-ionic moiety is selected from the group consisting of poly(ethylene glycol), a urethane, or combinations thereof, including combinations with the previously listed examples.

It is to be understood that the ionic solubilizing moieties disclosed herein (a sulfonate, a carboxylate, a phosphonate, an amine, and/or combinations thereof) may be in their ionic or non-ionic form, depending upon the pH of the solution containing the moiety. Some examples of the black inkjet inks disclosed herein have a pH that is neutral or higher (i.e., more basic), and then each of the sulfonate, carboxylate, and phosphonate moieties is in its ionic form, rather than its acid form. Some of the ionic moieties may be in salt form (e.g., SO₃⁻Na⁺, COO⁻Na⁺, K⁺H₂PO₃⁻) with any suitable cation, such as a sodium ion (Na⁺), a potassium ion (K⁺), a lithium ion (Li⁺), an ammonium ion (NH₄⁺), a primary ammonium ion (RNH₃⁺), a secondary ammonium ion (R₂NH₂⁺), a tertiary ammonium ion (R₃NH⁺), or a quaternary ammonium (R₄N⁺), wherein each R group of the primary, secondary, tertiary or quaternary ammonium ion is independently selected from an alkyl or aryl group. Some other examples of the black inkjet inks disclosed herein have a pH that is neutral or lower (i.e., more acidic), and then the amine moiety is in its ionic (cationic) form. When the dispersion synergist includes both an amine and a carboxyl solubilizing moiety, and depending upon the pH of the black inkjet ink, the pigment dispersion may be stabilized by i) the amine group in its ionic form at the acidic pH (7 or less), or ii) the carboxyl group in its ionic form at very basic pH (e.g., 9-10), or iii) by both at an intermediate pH (e.g., from 7-9). When the pH of the ink is between about 7 and about 9, both the carboxyl group and the amine group may be in their ionic forms, and the dispersion synergist may exhibit zwitterionic behavior (i.e., both anionic and cationic behavior).

As mentioned herein, the non-ionic moiety is selected from the group consisting of poly(ethylene glycol), poly(propylene glycol), a sulfonamide, a carboxamide, a urethane, and combinations thereof. In an example, the poly(ethylene glycol) may have a weight average molecular weight of 5,000 or less. In another example, the poly(ethylene glycol) may have a weight average molecular weight of 1,000 or less. The sulfonamide may be —SONH₂ and the carboxamide may be —CONH₂. The urethane may be —(CH₂)nOCONH₂ where n is 1 or 2.

The dispersion synergist is selected from the group consisting of a cyan dispersion synergist, a magenta dispersion synergist, a yellow dispersion synergist, and combinations thereof.

In an example of the black inkjet ink composition, the dispersion synergist includes at least a cyan dispersion synergist, and the cyan dispersion synergist is selected from the group consisting of:

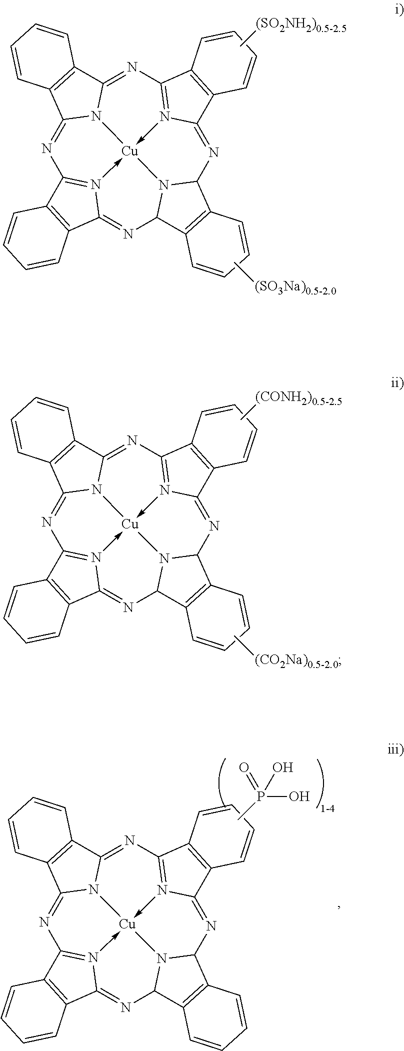

wherein at least one of the H protons is replaced by a sodium ion (Na⁺), a potassium ion (K⁺), a lithium ion (Li⁺), an ammonium ion (NH₄⁺), a primary ammonium ion (RNH₃⁺), a secondary ammonium ion (R₂NH₂⁺), a tertiary ammonium ion (R₃NH⁺), or a quaternary ammonium (R₄N⁺), and wherein each R group of the primary, secondary, tertiary or quaternary ammonium ion is independently selected from an alkyl or aryl group; and iv) combinations thereof.

The dispersion synergists represented by the structures (i, ii and iii) above are copper phthalocyanine-based dispersion synergists. The dispersion synergists with structures (i) or (ii) may include a cation other than sodium. For example, lithium, potassium or ammonium may replace the sodium (Na) cation.

The example copper phthalocyanine derivative (shown above as “i”) that is substituted with a sulfonate and a sulfonamide is known as Direct Blue 199 (or DB199), and may contain from 0.5 to 2 sulfonate moieties and from 0.5 to 2.5 sulfonamide moieties. This salt is also commercially available (for example, in powder or crystalline form, from a variety of suppliers as listed in the Colour Index).

The example dispersion synergist shown above as (ii) is also a copper phthalocyanine derivative, where the copper phthalocyanine is substituted with carboxylate and carboxamide moieties. This example may contain from 0.5 to 2 carboxylate moieties and from 0.5 to 2.5 carboxamide moieties.

The example dye synergist shown above as (iii) is also a copper phthalocyanine derivative, where the copper phthalocyanine is substituted with a phosphonate moiety. This example may contain from 1 to 4 phosphonate moieties.

While several examples of copper phthalocyanine derivatives have been described for the dispersion synergist of carbon black, it is to be understood that any other cyan dispersion synergist based on the copper phthalocyanine structure may be used as the dispersion synergist for carbon black.

In another example of the black inkjet ink composition, the dispersion synergist includes at least a magenta dispersion synergist, and the magenta dispersion synergist is selected from the group consisting of:

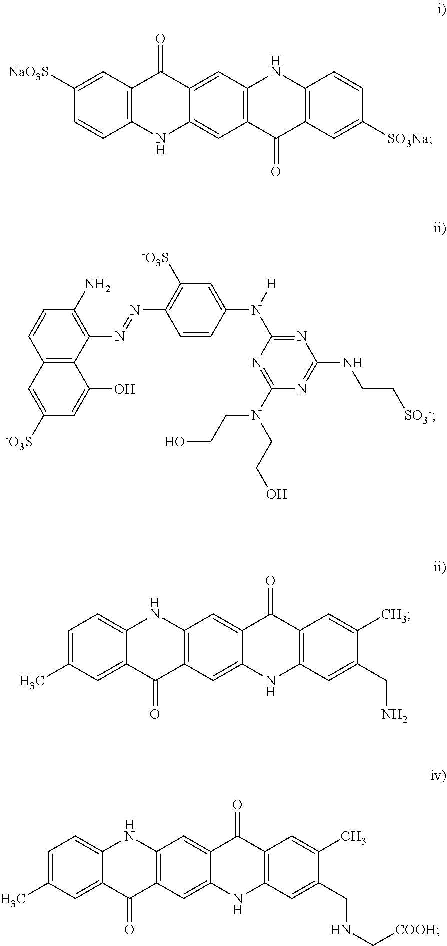

and

v) combinations thereof.

The dispersion synergists represented by the structures (i, iii and iv) above are quinacridone-based dispersion synergists.

The example magenta dispersion synergist shown above as (i) is a sulfonated derivative of the unsubstituted quinacridone known as Pigment Violet 19, which has the structure:

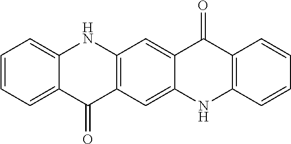 [SMILES: O=c1c2ccccc2[nH]c2cc3c(=O)c4ccccc4[nH]c3cc12]

The sulfonated quinacridone derivative (i) shown herein may be prepared by any suitable method. In an example, the unsubstituted quinacridone, Pigment Violet 19, may be heated in concentrated sulfuric acid, and then the quinacridone-sulfonic acid may be reacted with a suitable cation-containing aqueous solution. The cation may be sodium (as shown herein) or lithium, potassium or ammonium salts. In an example, the sulfonated quinacridone derivative has two ionic sulfonated moieties as depicted herein in the structure (i). In another example of the quinacridone dispersion synergist, one of ionic sulfonated moieties could be replaced with a non-ionic sulfonamide moiety. In still another example of the quinacridone dye dispersion synergist, both of the ionic sulfonated moieties could be replaced with non-ionic sulfonamide moieties. The structure (i) may include a cation other than sodium. For example, lithium, potassium or ammonium may replace the sodium (Na) cation. While several quinacridone derivatives have been shown and/or described, it is to be understood that any quinacridone magenta pigment derivative may be used in the ink disclosed herein.

The example magenta dispersion synergist shown above as (iii) can be synthesized from a phthalimide-methylated quinacridone, called phthalimidomethyl quinacridone with the structure:

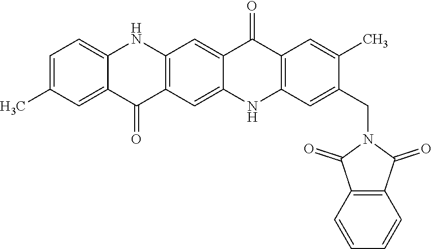 [SMILES: Cc1ccc2[nH]c3cc4c(=O)c5cc(C)c(CN6C(=O)c7ccccc7C6=O)cc5[nH]c4cc3c(=O)c2c1]

Phthalimidomethyl quinacridone may be treated with hydrazine as shown:

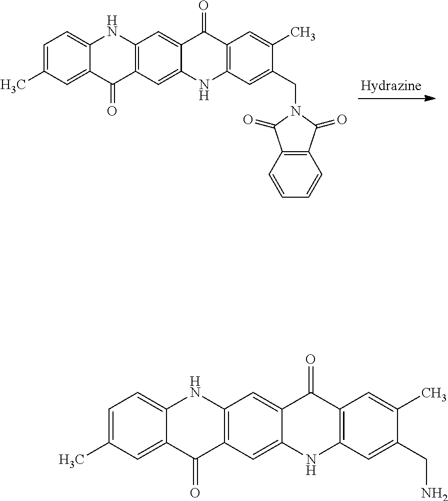 [SMILES: Cc1ccc2[nH]c3cc4c(=O)c5cc(C)c(CN6C(=O)c7ccccc7C6=O)cc5[nH]c4cc3c(=O)c2c1 ; Cc1ccc2[nH]c3cc4c(=O)c5cc(C)c(CN)cc5[nH]c4cc3c(=O)c2c1]

to form the magenta dispersion synergist (iii). The example magenta dispersion synergist shown above as (iii) is a cationic synergist and may be stable in acidic pH due to the amine functional group.

The example magenta dispersion synergist shown above as (iv) is an anionic dispersant synergist. This synergist can be derived from structure (iii) by treatment with dichloroacetic acid, as shown below:

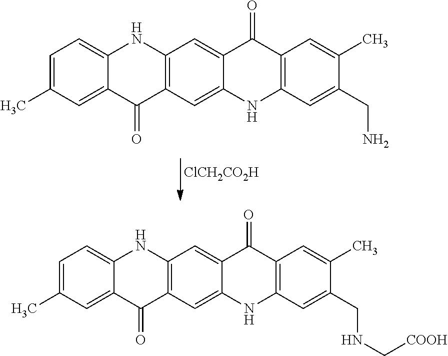

The structure (iv) above may be stable in acidic pH due to the amine functional group and also stable in alkaline pH due to the carboxylic acid group.

While several examples of magenta quinacridone derivatives have been described for the dispersion synergist of carbon black, it is to be understood that any other magenta dyes based on the quinacridone structure may be used as the dispersion synergist for carbon black.

The magenta dispersion synergist shown above as (ii) above is a dye synergist.

In still another example of the black inkjet ink composition, the dispersion synergist includes at least a yellow dispersion synergist, and the yellow dispersion synergist is selected from the group consisting of:

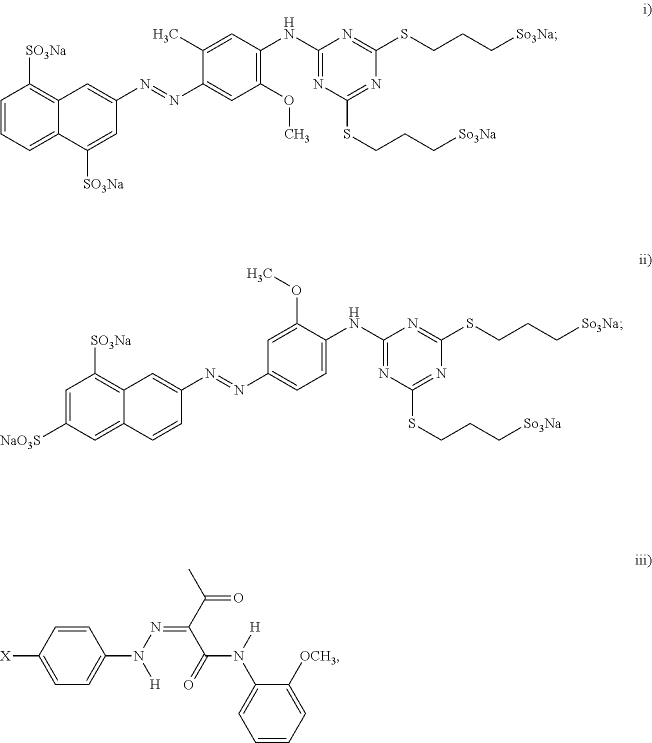

wherein X is the ionic moiety; and
iv) combinations thereof. For the yellow dispersion synergist structure represented by (iii) above, the ionic moiety X can be SO₃H, COOH, or NH₂.

In the examples disclosed herein, any of the dispersion synergists may be used alone, in combination with another synergist of the same color, or in combination with another synergist of a different color.

In an example of the black inkjet ink composition, the carbon black pigment and the dispersion synergist are present in a weight ratio of from about 8:1 to about 4:1. As such, the amount of the cyan, magenta or yellow dispersion synergist may depend upon the amount of carbon black pigment. In an example, when the carbon black pigment amount ranges from about 2 wt % to about 5 wt %, the cyan, magenta or yellow dye dispersion synergist amount ranges from 0.25 wt % to about 1.25 wt % based on the total weight of the black inkjet ink composition. It has been found that these ratios of carbon black pigment to dispersion synergist, in the presence of the polar solvent, form a composition that is reliably jettable from a thermal inkjet printhead, water fast, and able to form prints with desirable attributes (including a neutral hue) on plain, enhanced, and coated papers. It is believed that a similar carbon black pigment and the dispersion synergist weight ratio (i.e., from about 8:1 to about 4:1) may be incorporated into a composition that is reliably jettable from a piezoelectric inkjet printhead. This composition may have higher total solids content (than the thermal inkjet composition) and may have more co-solvent than water. The higher solids and solvent-based formulation may be reliably jetted from a piezoelectric printhead without having a deleterious effect on print reliability or print performance on plain, enhanced, and coated papers.

The cyan, magenta and yellow dyes and pigment derivatives that are shown and described herein are water-soluble or water-miscible, and can serve as a dispersant for the carbon black pigment in the presence of the polar solvent disclosed herein. In an aqueous medium (including the polar solvent and water), each cyan, magenta or yellow dye derivative may interact with the carbon black pigment particles, resulting in the formation of a stable pigment dispersion which may be used to formulate examples of the black inkjet inks disclosed herein.

Any example of the dispersion synergist together with the carbon black pigment may be incorporated into the black inkjet ink composition in the form of a black pigment dispersion, in which the carbon black pigment is dispersed with the dispersion synergist. The black pigment dispersion will be discussed in further detail below in conjunction with the method for making the black inkjet ink composition.

The black inkjet ink composition includes a polar solvent and water. These components are part of an aqueous-based ink vehicle. As used herein, the term “aqueous-based ink vehicle” and “ink vehicle,” may refer to the liquid fluid in which the carbon black pigment and the dispersion synergist are placed to form the black inkjet ink. When the carbon black pigment and dispersion synergist are part of a black pigment dispersion prior to ink formation, the black pigment dispersion may be added to the aqueous-based ink vehicle to form the black inkjet ink composition. In these examples, it is to be understood that some of the water and polar solvent in the final black inkjet ink composition is contributed by the liquids of the black pigment dispersion. In an example, the aqueous-based ink vehicle includes water, the polar solvent, and other liquid additives. In another example, the aqueous-based ink vehicle includes the polar solvent and the water with no other liquid additives.

The polar solvent is a co-solvent in the black inkjet ink. It is desirable for the co-solvent to be miscible with water, and thus the co-solvent has at least some degree of polarity. In an example, the co-solvent is selected from the group consisting of 2-pyrrolidone (2P), 1-(2-hydroxyethyl)-2-pyrrolidone (HE2P), 2-ethyl-2-hydroxymethyl-1,3-propanediol) (EHPD), tetraethylene glycol (TEG), sulfolane, and combinations thereof. Any individual polar solvent (when used in thermal inkjet printing) may be present in an amount ranging from about 5 wt % to about 50 wt % based on the total weight of the black inkjet ink composition. The total amount of the polar solvent may depend, in part, on whether a single polar solvent or multiple polar solvents are used, and may be much higher when multiple polar solvents are used in combination. When the black inkjet ink composition is to be used in piezoelectric inkjet printing, the polar solvent amount may be increased and the amount of water decreased. For example, when intended for piezoelectric printing, the amount of polar solvent may be greater than or equal to 50 wt %, based on the total weight of the black inkjet ink composition. As mentioned herein, the polar solvent in the ink may be contributed by the black pigment dispersion and by the aqueous-based ink vehicle. When the same polar solvent is used in the black pigment dispersion and the ink vehicle, the final black inkjet ink composition may include a single polar solvent. When different polar solvents are used in the black pigment dispersion and the ink vehicle, the final black inkjet ink composition may include different polar solvents. It has been found that the dispersability is also facilitated by the polar solvent that is used. As such, the polar solvent in the ink vehicle may contribute to enhancing the stability of the carbon black pigment dispersion.

The balance of the black inkjet ink composition is water. As mentioned herein, the water in the black inkjet ink may be contributed by the black pigment dispersion and by the aqueous-based ink vehicle. As such, the amount of water included may vary, depending upon the amounts of the other black inkjet ink components. In an example, the water is deionized water.

Some examples of the black inkjet ink composition may further include a metal oxide present in an amount ranging from about 0.5 wt % up to 7 wt %, based on a total weight of the black inkjet ink composition. In one example, the metal oxide can be present in an amount ranging from about 1 wt % to about 5 wt %, based on the total weight of the black inkjet ink composition. In another example, the metal oxide can be present in an amount ranging from about 0.5 wt % to about 2 wt %, based on the total weight of the black inkjet ink composition.

The metal oxide may serve as a networking agent (or gelator), which may form an effective network that may contribute to more carbon black remaining on the media surface after printing, even without the presence of calcium ions, thus resulting in an increase in carbon black saturation on plain paper. The metal oxide particles (which desirably have some charge) interact with each other and/or with the carbon black particles to form a three dimensional structure. As used herein, the term “metal oxide” refers to a molecule comprising at least one metal or semi-metal (e.g., Si) atom and at least one oxygen atom which in a particulate form is able to form the three dimensional structure (which is a structured network). As used herein, the term “semi-metal” includes boron, silicon, germanium, arsenic, antimony, and tellurium, for example. In an example, the black inkjet ink composition includes a metal oxide, wherein the metal oxide is selected from the group consisting of silica, alumina, titania, zinc oxide, iron oxide, indium oxide, zirconium oxide, or combinations thereof.

As such, without being bound to any theory, it is believed that when a metal oxide is included in the black inkjet ink, the metal oxide can interact with other metal oxide particles and/or with carbon black particles to create a shear thinning network which maintains association with the carbon black to improve color performance, especially on plain paper. The combination of these components, in their respective amounts as disclosed herein, have a synergistic effect which renders the ink performance independent of the components of the paper upon which it is printed.

The three dimensional structure may be enhanced in the presence of salt dissolved in the polar solvent and/or water. The salt can increase the interaction of the metal oxide particles, alone or in combination with the carbon black particles. Salt that interacts with the metal oxide may be from the ionic moiety of the some examples of the dispersion synergist or from some another salt that may be added to the ink composition. The ionic moiety (salt) and/or another organic salt to the ink can act to shield the electrostatic repulsion between carbon black particles and permit the Van der Waals interactions to increase, thereby forming a stronger attractive potential and resulting in a structured network by providing elastic content to a predominantly fluidic system. These structured systems show non-Newtonian flow behavior, thus providing useful characteristics for implementation in an inkjet ink because of their ability to shear or thermal thin for jetting. Once jetted, this feature allows the jetted drops to become more elastic-, mass-, or gel-like when they strike the media surface. These characteristics can also provide improved media attributes, such as carbon black holdout on the surface of plain paper. The role of the ionic moiety (salt) and/or other salt can impact both the jettability and the response after jetting, as well as improving the dispersability of the carbon black.

When silica is selected for the metal oxide, it is to be understood that different forms of silica may be used. Suitable forms of silica that may be used include anisotropic silica (e.g., elongated, covalently attached silica particles, such as PSM, which is commercially available from Nissan Chemical) or spherical silica dispersions (such as SNOWTEX® 30LH from Nissan Chemical). Other suitable commercially available silicas are sold under the tradename ORGANOSILICASOL™, which are organic solvent dispersed silica sols. In an example, the black inkjet ink composition includes silica, wherein the silica is anisotropic silica, spherical silica or a combination of anisotropic silica and spherical silica. Anisotropic silica dispersions have a higher aspect ratio compared to spherical silica.

The geometry, including the size, shape and aspect ratio of the metal oxide can influence certain properties of the black inkjet ink composition, such as viscosity. For example, at a given weight percent in an ink, metal oxide particles with a higher aspect ratio may yield a higher ink viscosity relative to metal oxide particles with a lower aspect ratio. Also, the viscosity of the ink may be reduced by incorporating a small amount of large sized particles, which act as spacers between carbon black pigment particles in the ink composition, and other smaller nanoparticle components that make up other solids in the black inkjet ink. In this example, the large sized particles may mediate particle-particle interaction between the smaller nanoparticles to reduce viscosity. In one example, the particle size of the metal oxide may range from about 5 nm to about 50 nm. In another example, the particle size of the metal oxide may range from about 10 nm to about 25 nm. Suitable tools that may be used to measure the length and/or width of the metal oxide include SEM (Scanning Electron Microscopy), TEM (Transmission Electron Microscopy), AFM (Atomic Force Microscopy), and DLS (Dynamic Light Scattering).

Examples of the black inkjet ink composition may also include other components, such as a sugar alcohol, an organic salt, an anti-kogation agent, a surfactant, a humectant, a biocide, a material for pH adjustment, and the like, and combinations thereof.

As mentioned herein, the black inkjet ink composition may further comprise a sugar alcohol. In an example, the sugar alcohol in the black inkjet ink composition is present in an amount ranging from greater than 0 wt % up to about 15 wt % based on the total weight of the black inkjet ink composition. The sugar alcohol can be any type of straight chain or cyclic sugar alcohol. In one example, the sugar alcohol can have the formula: H(HCHO)ₙ₊₁ H, where n is at least 3. Such sugar alcohols can include erythritol (4-carbon), threitol (4-carbon), arabitol (5-carbon), xylitol (5-carbon), ribitol (5-carbon), mannitol (6-carbon), sorbitol (6-carbon), galactitol (6-carbon), fucitol (6-carbon), iditol (6-carbon), inositol (6-carbon; a cyclic sugar alcohol), volemitol (7-carbon), isomalt (12-carbon), maltitol (12-carbon), lactitol (12-carbon), and mixtures thereof. In one example, the sugar alcohol can be a 5 carbon sugar alcohol. In another example, the sugar alcohol can be a 6 carbon sugar alcohol. In still another example, the black inkjet ink composition includes a sugar alcohol, wherein the sugar alcohol is selected from the group consisting of sorbitol, xylitol, mannitol, erythritol, and combinations thereof. The use of a sugar alcohol can improve the curl and rub/scratch resistance of prints formed with the black inkjet ink.

The black inkjet ink composition may also include anti-kogation agents. Kogation refers to the deposit of dried ink on a heating element of a thermal inkjet printhead. Anti-kogation agent(s) is/are included to assist in preventing the buildup of kogation. Examples of suitable anti-kogation agents include oleth-3-phosphate (commercially available as CRODAFOS™ O3A or CRODAFOS™ N-3 acid) or dextran 500 k. Other suitable examples of the anti-kogation agents include CRODAFOS™ HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc. When included, the anti-kogation agent may be present in the black inkjet ink composition in an amount ranging from about 0.05 wt % to about 1 wt % of the total weight of the black inkjet ink composition. In the examples disclosed herein, the anti-kogation agent may improve the jettability of the black inkjet ink composition.

The black inkjet ink composition may also include an organic salt that is different from the ionic (salt) forms of the dispersion synergist. In an example, the black inkjet ink composition further includes the organic salt present in an amount ranging from about 0.01 wt % to about 1 wt % based on the total weight of the black inkjet ink composition. In another example, the organic salt may be present in an amount ranging from about 0.05 wt % to about 0.5 wt % based on the total weight of the black inkjet ink composition.

Examples of the organic salt may include tetraethyl ammonium salts, tetramethyl ammonium salts, acetate salts, etc. In other examples, the organic salt can include salts of carboxylic acids (e.g., sodium or potassium 2-pyrrolidinone-5-carboxylic acid), sodium or potassium acetate, salts of citric acid or any organic acid including aromatic salts, and mixtures thereof. In one example, the organic salt is selected from the group consisting of sodium phthalate, tetraethyl ammonium, tetramethyl ammonium, monosodium glutamate, bis(trimethylsilyl) malonate, magnesium propionate, magnesium citrate, calcium acetate, magnesium acetate, sodium acetate, potassium acetate, barium acetate, and combinations thereof.

The presence of an organic salt, particularly a dissolved organic salt in the black inkjet ink, can further contribute to the structured network described herein. The organic salt or the organic salt in combination with the salt form of the dispersion synergist can act to shield the electrostatic repulsion between carbon black particles and permit the van der Waals interactions to increase, thereby forming a stronger attractive potential and resulting in a structured network (for the carbon black) by providing elastic content to a predominantly fluidic system. As mentioned herein, these structured systems show non-Newtonian flow behavior, thus providing useful characteristics for implementation in an inkjet ink because of their ability to shear thin or thermal thin (in the case of thermal inkjet inks) for jetting. Once jetted, this feature allows the jetted drops to become more elastic-, mass-, or gel-like when they strike the media surface. These characteristics can also provide improved media attributes, such as carbon black holdout on the surface of plain paper. Therefore, the role of the added organic salt can impact both the jettability of the black inkjet ink as well as the response after jetting.

The black inkjet ink composition may also include surfactant(s). Examples of suitable surfactants include sodium dodecyl sulfate (SDS), a linear, N-alkyl-2-pyrrolidone (e.g., SURFADONE™ LP-100 from Ashland Inc.), a self-emulsifiable, nonionic wetting agent based on acetylenic diol chemistry (e.g., SURFYNOL® SEF from Evonik Ind.), a nonionic fluorosurfactant (e.g., CAPSTONE® fluorosurfactants, such as CAPSTONE® FS-35, from Chemours), and combinations thereof. In other examples, the surfactant is an ethoxylated low-foam wetting agent (e.g., SURFYNOL® 440 or SURFYNOL® CT-111 from Evonik Ind.) or an ethoxylated wetting agent and molecular defoamer (e.g., SURFYNOL® 420 from Evonik Ind.). Still other suitable surfactants include non-ionic wetting agents and molecular defoamers (e.g., SURFYNOL® 104E from Evonik Ind.) or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TECO® Wet 510 (polyether siloxane) available from Evonik Ind.). In some examples, it may be desirable to utilize a surfactant having a hydrophilic-lipophilic balance (HLB) less than 10. Whether a single surfactant is used or a combination of surfactants is used, the total amount of surfactant(s) in the black inkjet ink composition may range from about 0.01 wt % to about 10 wt % based on the total weight of the black inkjet ink composition. In an example, the total amount of surfactant(s) in the black inkjet ink composition may be about 0.1 wt % based on the total weight of the black inkjet ink composition.

The black inkjet ink composition may also include humectant(s). In an example, the total amount of the humectant(s) present in the black inkjet ink composition ranges from about 1 wt % to about 1.25 wt %, based on the total weight of the black inkjet ink composition. An example of a suitable humectant is ethoxylated glycerin having the following formula:

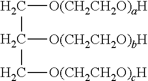

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

The black inkjet ink composition may also include biocides (i.e., fungicides, anti-microbials, etc.). Example biocides may include the NUOSEPT™ (Troy Corp.), UCARCIDE™ (Dow Chemical Co.), ACTICIDE® B20 (Thor Chemicals), ACTICIDE® M20 (Thor Chemicals), ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof. Examples of suitable biocides include an aqueous solution of 1,2-benzisothiazolin-3-one (e.g., PROXEL® GXL from Arch Chemicals, Inc.), quaternary ammonium compounds (e.g., BARDAC® 2250 and 2280, BARQUAT® 50-65B, and CARBOQUAT® 250-T, all from Lonza Ltd. Corp.), and an aqueous solution of methylisothiazolone (e.g., KORDEK® MLX from Dow Chemical Co.). In an example, the black inkjet ink composition may include a total amount of biocides that ranges from about 0.05 wt % to about 1 wt %, based on the total weight of the black inkjet ink composition.

In an example, it may be desirable for the black inkjet ink composition to have a pH ranging from about 7 to about 10, and pH adjuster(s) may be added to the black inkjet ink composition to counteract any slight pH drop that may occur over time. The ionic moieties of some examples of the dispersion synergist will be in ionic form within this pH range. In an example, the total amount of pH adjuster(s) in the black inkjet ink composition ranges from greater than 0 wt % to about 0.1 wt % (with respect to the total weight of the black inkjet ink composition). Examples of suitable pH adjusters include metal hydroxide bases, such as sodium hydroxide (NaOH), potassium hydroxide (KOH), etc. In another example, it may be desirable for the black inkjet ink composition to have a pH ranging from about 4 to about 7. An acidic pH may be desirable when the dispersion synergist includes an amine as the functional group, providing aqueous solubility.

A total solids content of the black inkjet ink composition (when used in thermal inkjet printing) ranges from about 2.5 wt % to about 12 wt % based on the total weight of the black inkjet ink composition. When the black inkjet ink composition is to be used in piezoelectric inkjet printing, the solids content may be increased. For example, when the black inkjet ink composition is intended for use with piezoelectric inkjet printheads, a final ink solids content may range from about 10% to about 25% based on the total weight of the black inkjet ink composition, without having a deleterious effect on print reliability or print performance.

Method for Making the Black Inkjet Ink Composition

In addition to the black inkjet ink composition described herein, a method 100 for making the black inkjet ink composition is disclosed. Referring now to the FIGURE, the method 100 comprises forming a black pigment dispersion including a carbon black pigment, a dispersion synergist having an aromatic structure substituted with at least one solubilizing moiety selected from the group consisting of an ionic moiety, a non-ionic moiety and a combination thereof, a polar solvent, and water (as shown at reference numeral 102), and incorporating the black pigment dispersion into an aqueous-based ink vehicle (as shown at reference numeral 104). This aqueous-based ink vehicle may include a second polar solvent that is the same as or different than the polar solvent in the black pigment dispersion, and additional water. The preparation of the black pigment dispersion involves a simple process, in part because the carbon black pigment and dispersion synergist share structurally similarity and thus compatibility, in both possessing aromatic rings. The carbon black pigment and dispersion synergist are mixed together. The mixture may be added to a solution of the water and the polar solvent, or the solution of the water and the polar solvent may be added to the mixture. The components may be mixed with a suitable mixer until the dispersion is formed. In an example, mixing is accomplished with a mill and milling beads or another suitable high shear mixer. After mixing, the dispersion may be centrifuged to remove the milling beads.

In an example of the method 100, the dispersion synergist is selected from the group consisting of:

i) a cyan dispersion synergist selected from the group consisting of:

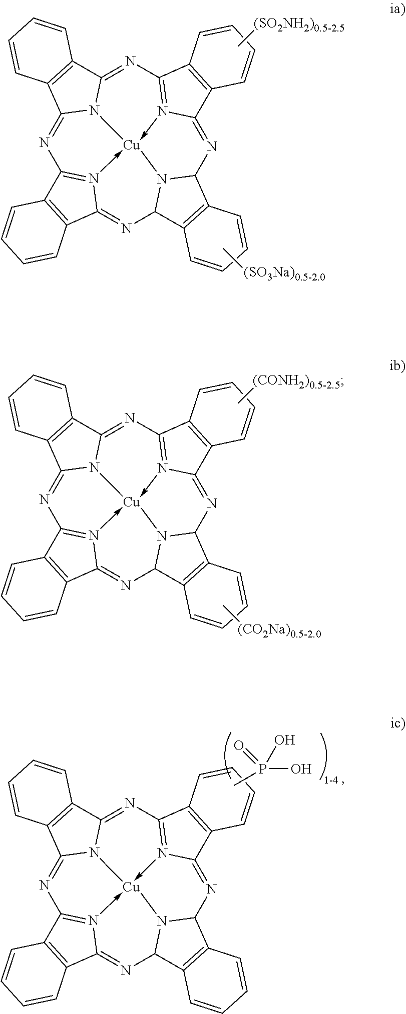

wherein at least one of the H protons is replaced by a sodium ion (Na⁺), a potassium ion (K⁺), a lithium ion (Li⁺), an ammonium ion (NH₄⁺), a primary ammonium ion (RNH₃⁺), a secondary ammonium ion (R₂NH₂⁺), a tertiary ammonium ion (R₃NH⁺), or a quaternary ammonium (R₄N⁺), and wherein each R group of the primary, secondary, tertiary or quaternary ammonium ion is independently selected from an alkyl or aryl group; and

id) combinations thereof;

ii) a magenta dispersion synergist selected from the group consisting of:

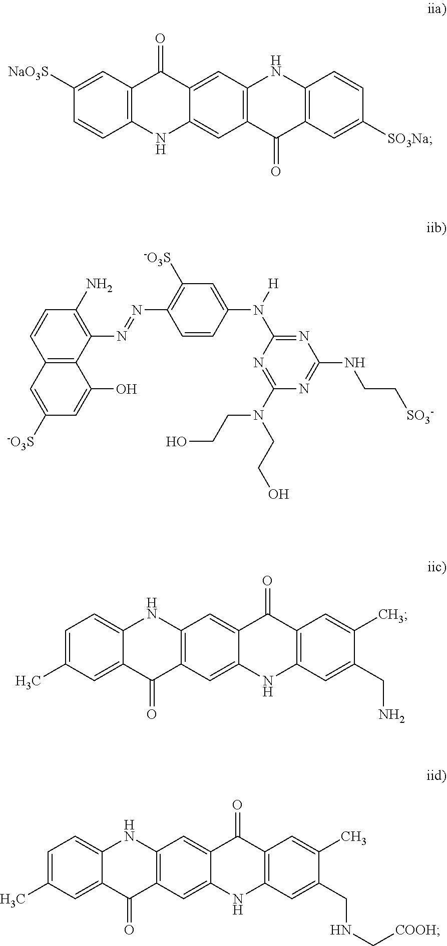

and

iie) combinations thereof;

iii) a yellow dispersion synergist selected from the group consisting of:

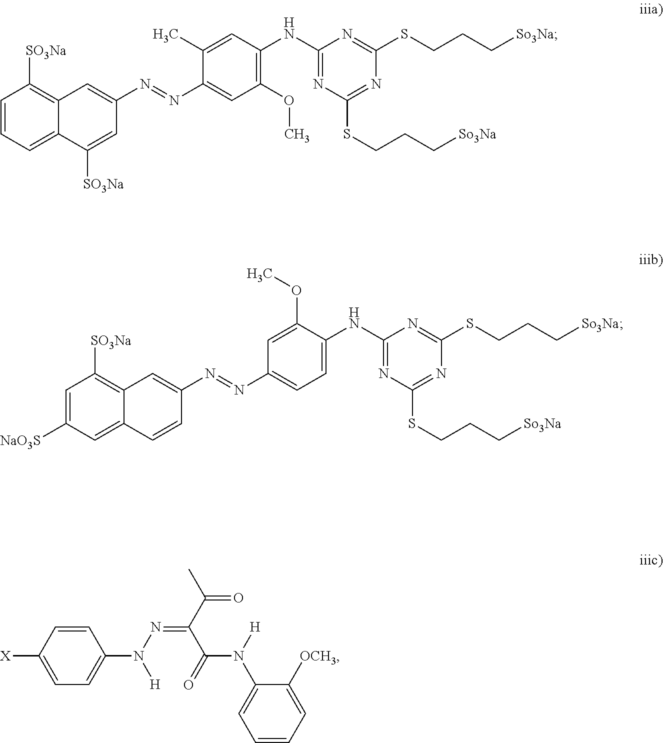

wherein X is the ionic moiety; and

iiid) combinations thereof, and

iv) combinations of the cyan dispersion synergist, the magenta dispersion synergist, and the yellow dispersion synergist. For the structure represented by iiic, the ionic moiety X can be SO₃H, COOH, or NH₂.

The black pigment dispersion may include from about 10 wt % to about 20 wt % of the carbon black (based on the total weight of the black pigment dispersion), from about 1.25 wt % to about 5 wt % of the dispersion synergist (based on the total weight of the black pigment dispersion), from about 15 wt % to about 25 wt % of the polar solvent (based on the total weight of the black pigment dispersion), and a balance of water. In the black pigment dispersion, the amount of the dispersion synergist may depend upon the amount of carbon black and the desired weight ratio of carbon black to dispersion synergist in the black pigment dispersion and in the black inkjet ink.

As shown at reference numeral 104, the black pigment dispersion may then be incorporated into the aqueous-based ink vehicle. The amount of black pigment dispersion added will depend upon the amount of carbon black and dispersion synergist in the black pigment dispersion and the desired weight of active carbon black and active dispersion synergist that are to be present in the final black inkjet ink. The amount of active carbon black and active dispersion synergist are in accordance with the examples set forth herein for the black inkjet ink composition. The aqueous-based ink vehicle may include a second polar solvent that is the same as or different than the polar solvent in the black pigment dispersion and additional water (i.e., water that is not part of the black pigment dispersion, and thus is in addition to the water of the black pigment dispersion). In some examples, the aqueous-based vehicle may also include any of the liquid ink additives disclosed herein in any of the amounts disclosed herein. In other examples, water alone makes up the aqueous-based ink vehicle.

The method 100 may further comprise incorporating a metal oxide into the aqueous-based ink vehicle. In an example, the metal oxide is added after the black pigment dispersion is incorporated into the aqueous-based ink vehicle. In another example, the metal oxide is added into the aqueous-based ink vehicle before the black pigment dispersion is incorporated into the aqueous-based ink vehicle. In still another example, the black pigment dispersion and metal oxide are added into the aqueous-based ink vehicle simultaneously. Regardless of the order of adding the components, the final dispersion yields the black inkjet ink composition. In an example of the method 100, the metal oxide is present in an amount ranging from 0.5 wt % up to 7 wt % based on the total weight of the black inkjet ink composition.

In another example, the method 100 further comprises incorporating a sugar alcohol into the aqueous-based ink vehicle in an amount ranging from greater than 0 wt % up to about 15 wt % based on the total weight of the inkjet ink composition.

In the example method 100 shown in the FIGURE, the carbon black and the dispersion synergist are added to the aqueous-based ink vehicle in the form of the black pigment dispersion.

In an example of the method 100 that is suitable for making a black thermal inkjet ink composition, the polar solvent may be present in an amount ranging from about 10 wt % to about 50 wt % based on the total weight of the black inkjet ink composition, and a total solids content of the black inkjet ink composition ranges from about 2.5 wt % to about 12 wt % based on the total weight of the black thermal inkjet ink composition. To make an example of a piezoelectric inkjet formulation, the polar solvent amount and the solids content may be increased in accordance with the amounts set forth herein.

Printing Method

A printing method is also disclosed herein. The printing method comprises inkjet printing a black inkjet ink composition onto at least a portion of a paper without printing a colored ink onto on the at least the portion, the black inkjet ink composition including a carbon black pigment, a dispersion synergist having an aromatic structure substituted with at least one solubilizing moiety selected from the group consisting of an ionic moiety, a non-ionic moiety and a combination thereof, a polar solvent, and water.

In an example of the printing method, the dispersion synergist is selected from the group consisting of:

i) a cyan dispersion synergist selected from the group consisting of:

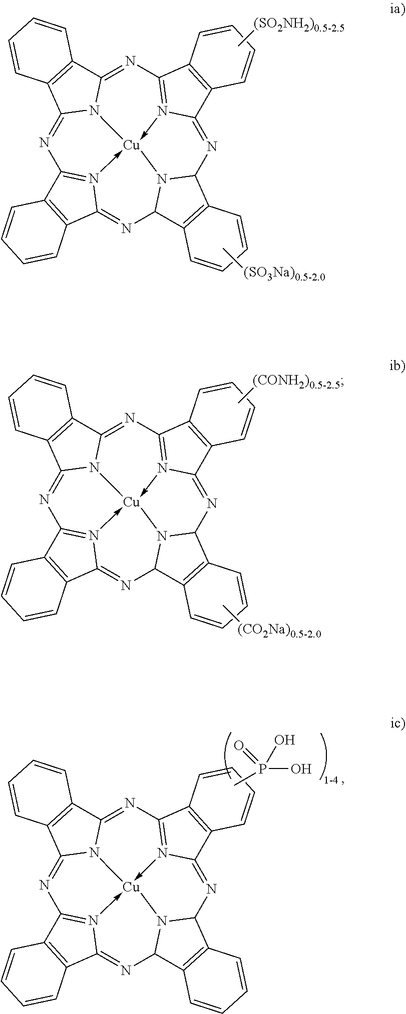

wherein at least one of the H protons is replaced by a sodium ion (Na⁺), a potassium ion (K⁺), a lithium ion (Li⁺), an ammonium ion (NH₄⁺), a primary ammonium ion (RNH₃⁺), a secondary ammonium ion (R₂NH₂⁺), a tertiary ammonium ion (R₃NH⁺), or a quaternary ammonium (R₄N⁺), and wherein each R group of the primary, secondary, tertiary or quaternary ammonium ion is independently selected from an alkyl or aryl group; and

id) combinations thereof;

ii) a magenta dispersion synergist selected from the group consisting of:

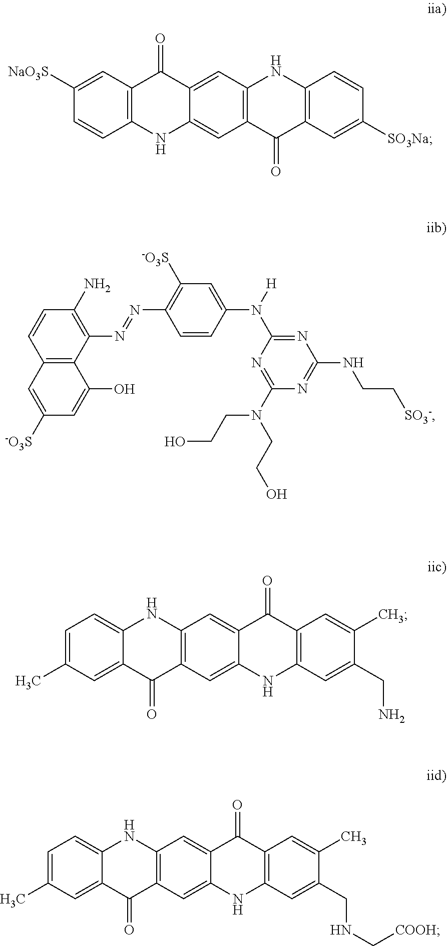

and

iie) combinations thereof;

iii) a yellow dispersion synergist selected from the group consisting of:

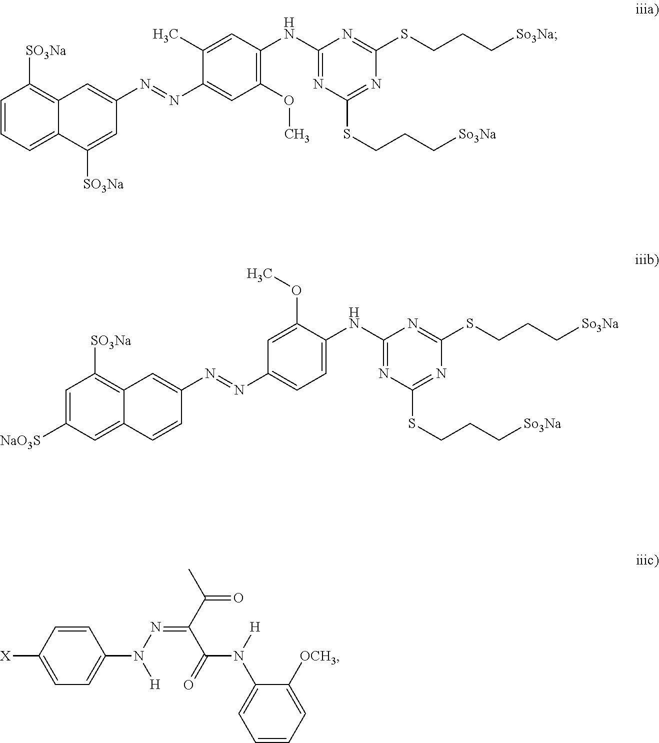

wherein X is the ionic moiety; and

iiid) combinations thereof; and

iv) combinations of the cyan dispersion synergist, the magenta dispersion synergist, and the yellow dispersion synergist. For the structure yellow dispersion synergist represented by (iiic), the ionic moieties can be SO₃H, COOH, or NH₂.

The paper in the printing method may be either plain paper, enhanced paper, or coated paper. In some instances, the printing method includes printing on plain paper, printing on enhanced paper and printing on coated paper in any order. In one example of the printing method, an image is formed by printing the ink composition disclosed herein on plain paper and another image is formed by printing the ink composition on enhanced paper (including an additive that produces a chemical interaction with the pigment in the ink composition). In still another example of the printing method, an image is formed by printing the ink composition disclosed herein on coated paper.

It is to be understood that the ranges provided herein include the stated range and any value or sub-range within the stated range, as if the value(s) or sub-range(s) within the stated range were explicitly recited. For example, a range from about 5 wt % to about 50 wt % should be interpreted to include not only the explicitly recited limits of from about 5 wt % to about 50 wt %, but also to include individual values, such as 7.5 wt %, 25 wt %, 41 wt %, etc., and sub-ranges, such as from about 8.5 wt % to about 45 wt %, from about 15 wt % to about 35.7 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A black inkjet ink composition, comprising:
a carbon black pigment;
a dispersion synergist having an aromatic structure substituted with at least one solubilizing moiety selected from the group consisting of an ionic moiety, a non-ionic moiety, and a combination thereof;
a polar solvent; and
water.

2. The black inkjet ink composition as defined in claim 1 wherein the dispersion synergist is selected from the group consisting of a cyan dispersion synergist, a magenta dispersion synergist, a yellow dispersion synergist, and combinations thereof.

3. The black inkjet ink composition as defined in claim 2 wherein the dispersion synergist includes at least the cyan dispersion synergist, and the cyan dispersion synergist is selected from the group consisting of: 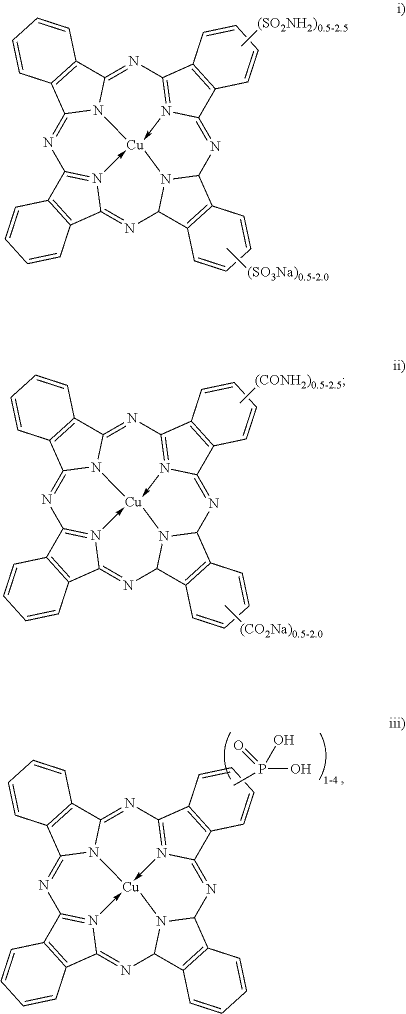
wherein at least one of the H protons is replaced by a sodium ion (Na⁺), a potassium ion (K⁺), a lithium ion (Li⁺), an ammonium ion (NH₄⁺), a primary ammonium ion (RNH₃⁺), a secondary ammonium ion (R₂NH₂⁺), a tertiary ammonium ion (R₃NH⁺), or a quaternary ammonium (R₄N⁺), and wherein each R group of the primary, secondary, tertiary or quaternary ammonium ion is independently selected from an alkyl or aryl group; and
iv) combinations thereof.

4. The black inkjet ink composition as defined in claim 2 wherein the dispersion synergist includes at least the magenta dispersion synergist, and the magenta dispersion synergist is selected from the group consisting of: 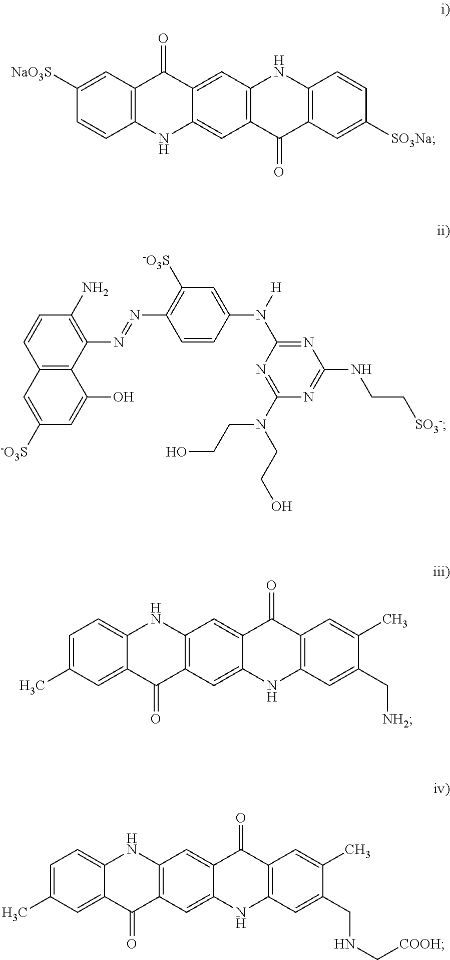
and
v) combinations thereof.

5. The black inkjet ink composition as defined in claim 2 wherein the dispersion synergist includes at least the yellow dispersion synergist, and the yellow dispersion synergist is selected from the group consisting of: 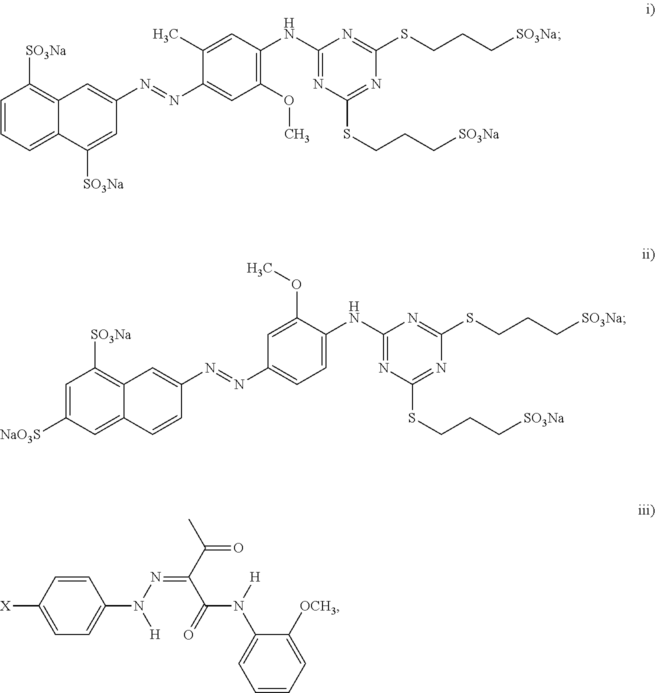
wherein X is the ionic moiety; and
iv) combinations thereof.

6. The black inkjet ink composition as defined in claim 1 wherein the carbon black pigment and the dispersion synergist are present in a weight ratio of from about 8:1 to about 4:1.

7. The black inkjet ink composition as defined in claim 1, further comprising a sugar alcohol present in an amount ranging from greater than 0 wt % up to about 15 wt % based on a total weight of the black inkjet ink composition.

8. The black inkjet ink composition as defined in claim 1, further comprising a metal oxide present in an amount ranging from about 0.5 wt % up to 7 wt %, based on a total weight of the black inkjet ink composition.

9. The black inkjet ink composition as defined in claim 1 wherein one of:
the solubilizing moiety is the ionic moiety and the ionic moiety is selected from the group consisting of a sulfonate, a carboxylate, a phosphonate, an amine, and combinations thereof; or
the solubilizing moiety is the non-ionic moiety and the non-ionic moiety is selected from the group consisting of poly(ethylene glycol), poly(propylene glycol), a sulfonamide, a carboxamide, a urethane, and combinations thereof.

10. The black inkjet ink composition as defined in claim 1 wherein the solubilizing moiety includes the combination of the ionic moiety and the non-ionic moiety, wherein the ionic moiety is selected from the group consisting of a sulfonate, a carboxylate, and a phosphonate, and wherein the non-ionic moiety is selected from the group consisting of a sulfonamide and a carboxamide.

11. A method for making a black inkjet ink composition, comprising:
forming a black pigment dispersion including:
a carbon black pigment;
a dispersion synergist having an aromatic structure substituted with at least one solubilizing moiety selected from the group consisting of an ionic moiety, a non-ionic moiety and a combination thereof;
a polar solvent; and
water; and
incorporating the black pigment dispersion into an aqueous-based ink vehicle.

12. The method as defined in claim 11, further comprising incorporating a metal oxide to the into the aqueous-based ink vehicle.

13. The method as defined in claim 11 wherein the dispersion synergist is selected from the group consisting of:
i) a cyan dispersion synergist selected from the group consisting of: 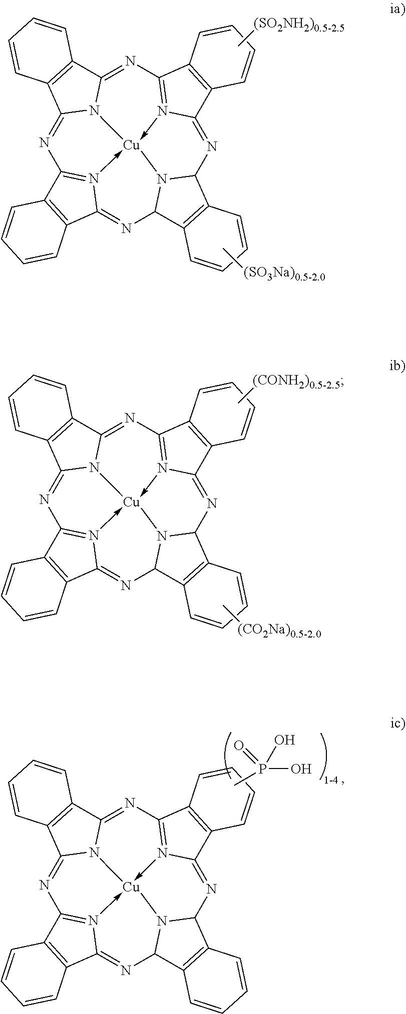
wherein at least one of the H protons is replaced by a Na⁺ or a K⁺; and
id) combinations thereof;
ii) a magenta dispersion synergist selected from the group consisting of: 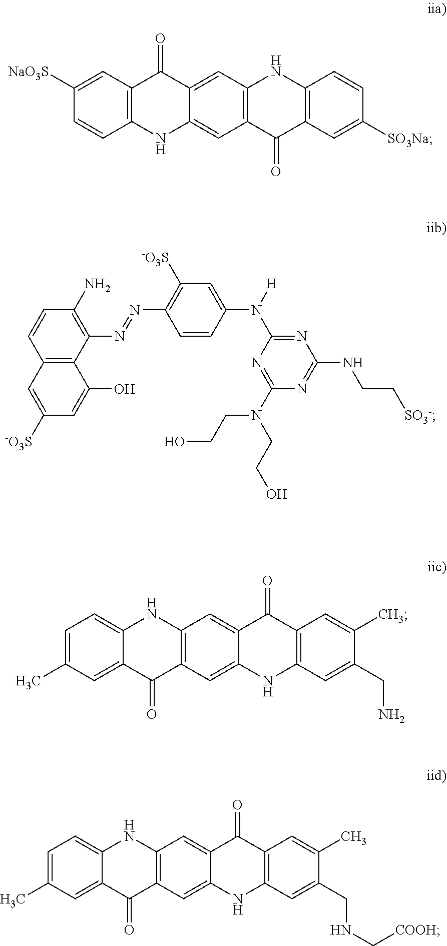
and
iie) combinations thereof;
iii) a yellow dispersion synergist selected from the group consisting of: 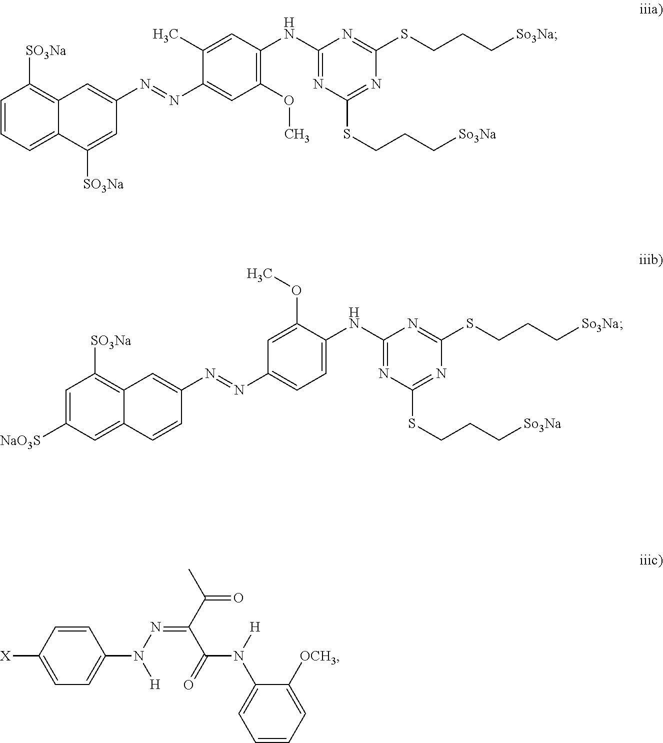
wherein X is the ionic moiety; and
iiid) combinations thereof; and
iv) combinations of the cyan dispersion synergist, the magenta dispersion synergist, and the yellow dispersion synergist.

14. A printing method, comprising:
inkjet printing a black inkjet ink composition onto at least a portion of a paper without printing a colored ink onto on the at least the portion, the black inkjet ink composition including:
a carbon black pigment;
a dispersion synergist having an aromatic structure substituted with at least one solubilizing moiety selected from the group consisting of an ionic moiety, a non-ionic moiety and a combination thereof;
a polar solvent; and
water.

15. The printing method as defined in claim 14 wherein the dispersion synergist is selected from the group consisting of:
i) a cyan dispersion synergist selected from the group consisting of: 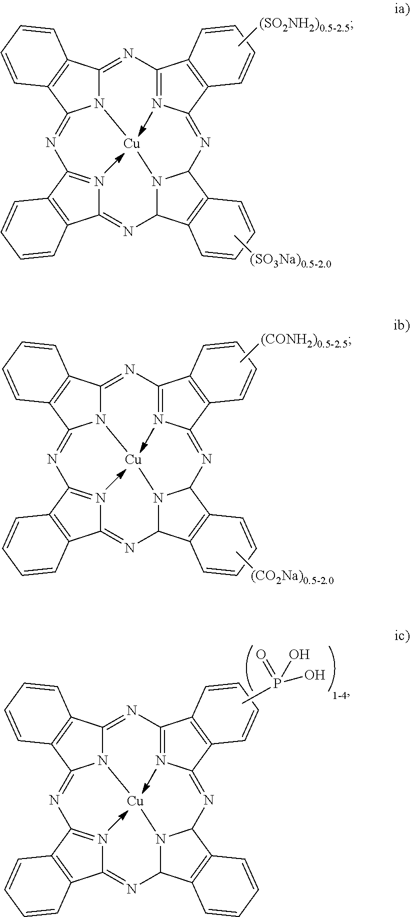
wherein at least one of the H protons is replaced by a Na⁺ or a K⁺; and
id) combinations thereof;
ii) a magenta dispersion synergist selected from the group consisting of: 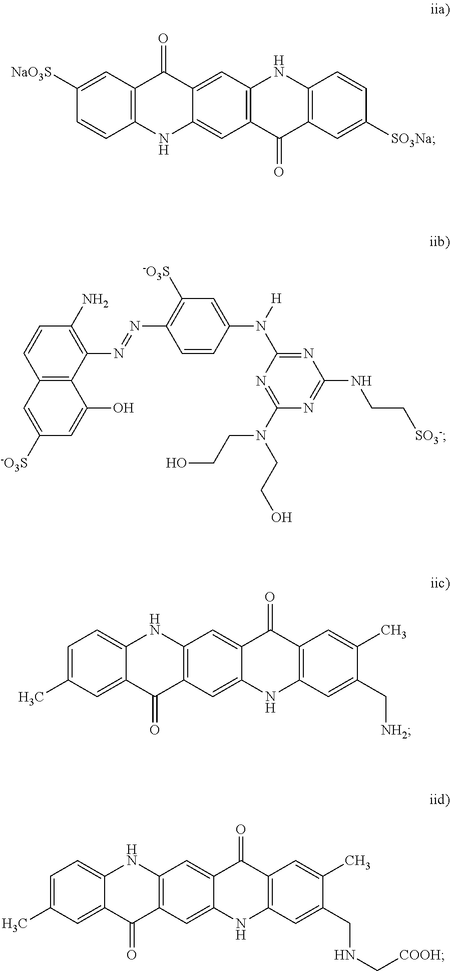
and
iie) combinations thereof;
iii) a yellow dispersion synergist selected from the group consisting of: 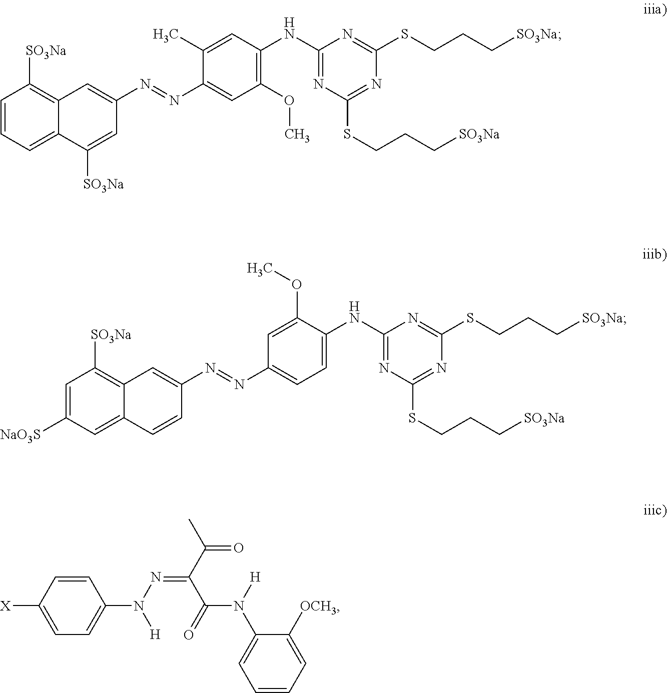
wherein X is the ionic moiety; and
iiid) combinations thereof; and
iv) combinations of the cyan dispersion synergist, the magenta dispersion synergist, and the yellow dispersion synergist.
